(19) United States
(12) Patent Application Publication
(10) Pub. No.: US 2002/0107707 A1
(43) Pub. Date: Aug. 8, 2002

(54) System and method for providing personalized health interventions over a computer network

(75) Inventors: Aaron Naparstek, Brooklyn, NY (US); Belleruth Naparstek, Cleveland Hts., OH (US); George Klein, Beachwood, OH (US)

Correspondence Address: KENYON & KENYON, ONE BROADWAY, NEW YORK, NY, 10004, US

(73) Assignee: ImagePaths.com LLC

(21) Appl. No.: 09/776,997

(22) Filed: Feb. 5, 2001

(51) Int. Cl. G06F 17/60

(52) U.S. Cl. 705/3

(57) ABSTRACT

A system and method of delivering personalized health interventions to a client over a computer network are provided. A user interface is provided to a client over the computer network, and health issue information is received back from the client. Personalized health interventions directed to the client are determined based on the received information. Selected audio and/or visual health interventions are delivered to the client. The selected interventions are presented to the client in the form of a daily health intervention schedule listing interventions by time. The schedule includes links to several health interventions which can be accessed through a client computer screens. The schedule may be linked with local scheduling applications.

### FIELD OF THE INVENTION

The present invention relates to Internet-enabled computer applications, and in particular to a system and method for providing personalized health interventions over a computer network.

### BACKGROUND INFORMATION

By some estimates, corporate healthcare costs are increasing by as much as 9% per year. Common health problems such as lower back pain, eyestrain and chronic stress reduce productivity and contribute to the extensive health costs. To help defray costs, alternative and preventative health treatment programs are being promoted in the corporate environment to ameliorate these common work-related health problems. The scope of these programs range widely from circulation of informational brochures to implementation of on-site classes, such as yoga instruction.

The applicability of these programs is limited in many circumstances. Due to inconvenience, employee adoption and adherence rates may be lower than desired. The expense and difficulty of servicing satellite offices, growing populations of telecommuters and off-site employees may be prohibitive. In addition, small and medium-sized enterprises may not be able to afford to offer such sophisticated health services and benefits to their employees.

Given the increasing percentage of time employees spend working on networked computer terminals, provision of health services through the Internet can be a more applicable and effective mode of imparting health treatments and information to employees. Moreover, the Internet enables interactive applications that can tailor customized health services to individuals. However, in spite of the clear advantages that Internet health products can potentially offer, the vast majority of today's Internet health products are designed to deliver information to passive consumers and do not enable individuals to engage actively in their own health programs.

What is therefore needed is an online health product that leverages the interactivity of the Internet to deliver innovative personalized treatments and therapies to the immediate workplace environment.

### SUMMARY OF THE INVENTION

The present invention provides a method of delivering personalized health interventions to a client over a computer network. A user interface is provided to a client over the computer network, and health issue information is received back from the client. Personalized health interventions directed to the client are determined based on the received information. Selected audio and/or visual health interventions are delivered to the client. The selected interventions are presented to the client in the form of a daily health intervention schedule listing interventions by time. The schedule includes links to several health interventions which can be accessed through a client computer screens. The schedule may be linked with local scheduling applications.

The present invention also provides access to a wide range of health information on a navigable Web site. The information is categorized into three main groups of health issues, therapies and practitioners.

To present to the client a health schedule that is best suited to ameliorate his or her health problems, a personalization algorithm is employed in selecting appropriate health interventions. The primary factor involved in the selection algorithm is the significance rating number each client provides for the list of health issues, each rating number indicating the significance of the particular health issue to the client. The health issues are then matched to interventions based on a relatedness scale. Threshold values may be used to filter out less related interventions, and to select only those interventions particularly effective in treating the highlighted health issues. Other factors may enter into the personalization algorithm such as favored therapy choices, gender, age and pregnancy status.

The user interface can be tailored for the corporate workplace by incorporating corporate guidelines for using the health interventions and services provided. The corporate guidelines may include restrictions on type of intervention that may be delivered, a time of day during which interventions can be delivered, and promotions of particular interventions.

An administrative back end interface is used to maintain the user interface and a database of health and client information. An administrator may add interventions, therapies, health issues and practitioners to the database to expand health services and also modify pre-existing client information and health information in the database.

In addition, the present invention provides a system for delivering personalized health interventions to a client over a computer network. The system includes a Web server adapted to provide a user interface to a client over the computer network and to receive information from the client through the computer network related to health issues. The Web server interacts with a database for operations such as storing client information and retrieving general health information resources and transmits audio/visual health interventions to the client through an audio/visual module.

### BRIEF DESCRIPTION OF THE DRAWINGS

FIG. 1 is a schematic illustration of a computer network system in which the DesktopSpa application operates.

FIG. 2 illustrates an embodiment of the DesktopSpa application.

FIG. 3 shows the Web site map of the DesktopSpa Web site according to an embodiment of the present invention.

FIG. 4 shows the home page of the DesktopSpa Web site according to an embodiment of the present invention.

FIG. 5 shows the registration page of the DesktopSpa Web site according to an embodiment of the present invention.

FIG. 6 shows the schedule page of the DesktopSpa Web site according to an embodiment of the present invention.

FIG. 7a illustrates an embodiment of a dialog box that request a client to provide information as to how the reminder event should be delivered boxes which appear when reminders are set.

FIG. 7b illustrates an embodiment of a dialog box that requests a selection of the time to set the reminder to occur.

FIG. 7c illustrates an embodiment of a dialog box that displays a confirmation that a reminder has been set.

FIG. 8 displays an embodiment of a database schema for the DesktopSpa application.

FIG. 9 shows a well o-gram email interface according to an embodiment of the present invention.

FIG. 10 shows an individual health issue page according to an embodiment of the present invention.

FIG. 11 shows an individual therapy page according to an embodiment of the present invention.

FIG. 12 shows an individual practitioner page according to an embodiment of the present invention.

FIG. 13 shows a tool home page of the back end administrative site according to an embodiment of the present invention.

FIG. 14 shows an “add a treatment” form according to an embodiment of the present invention.

FIG. 15 shows an “edit a treatment” form according to an embodiment of the present invention.

FIG. 16 shows a user tool page according to an embodiment of the present invention.

FIG. 17 shows a corporate tool page according to an embodiment of the present invention.

### DETAILED DESCRIPTION

The DesktopSpa is an office application based in an online platform through which clients can obtain personalized health treatments. Through the publicly accessible front end, clients register and log on to the DesktopSpa Web site, and thereafter input personal information on Web-page forms, browse the various health issues, therapies and practitioner information organized on the Web site, select and obtain specific health interventions, and schedule a health treatment schedule. The health interventions are generally one-to-five minute audio and video interventions created by noted health practitioners.

The DesktopSpa application includes an administrative back end through which administrators upload new treatments, and classify the treatments according to their particular use by health issue, therapy and practitioner. The treatments are also associated with various other rating types to better target the intervention to the specific needs of individual clients. All information provided on the DesktopSpa can also be updated and modified through the administrative back end.

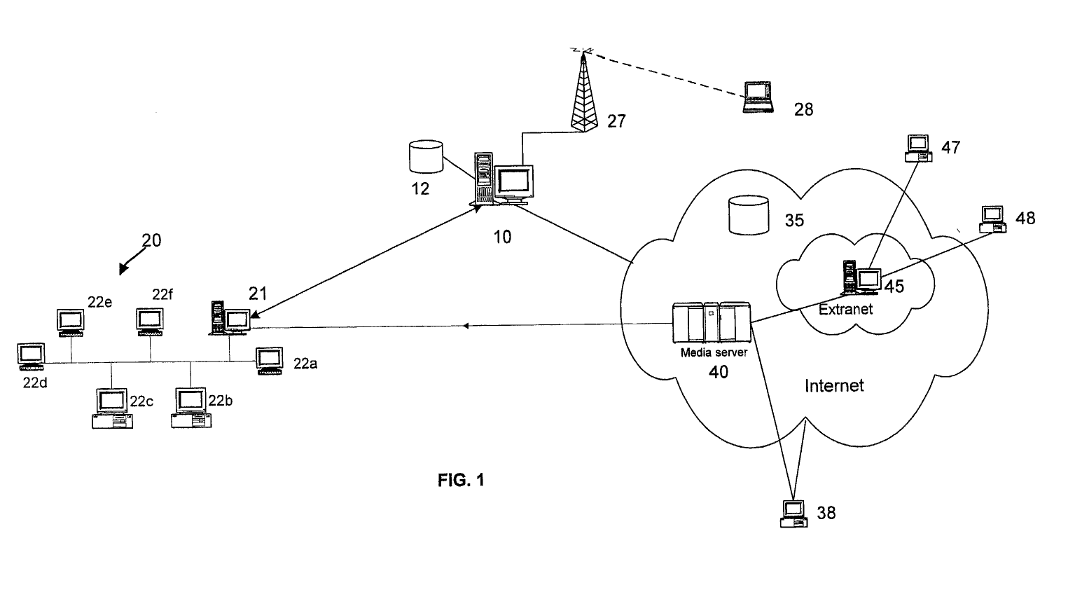

FIG. 1 illustrates an exemplary computer network system in which the DesktopSpa application operates. Application server 10 supports the Desktop Web site in conjunction with database 12 and various other external utilities as will be described. A corporate intranet 20 which includes server 21 and client PCs or workstations 22a, 22b . . . 22f, is coupled via an IP (Internet Protocol) network such as a virtual private network to the application server 10. The client computers 22a, 22b . . . 22f thereby have access to the health treatments provided by the DesktopSpa application. The application server 10 also communicates through a mobile services enabler 27 to various laptops or personal digital assistants represented by a single computer 28.

The media content of the various treatments are stored externally from the application server 10 at a media server 40. When, during an interactive session, a particular client, for example, 22e requests delivery of an intervention, the application accesses the media server through a URL (Uniform Resource Locator) link over the Internet. After the particular file which stores the intervention has been accessed, the media server sends the intervention content directly to the client 22e.

The application server 10 may also access outsourced database server 35 through an Internet connection. It should be noted that the external media 40 and database sources 35 could be co-located with the application server 10 in a given implementation. Other clients 38, 47 and 48, connected to the Internet through either a regular connection or through an extranet carved out of the Internet can also access the DesktopSpa application and receive treatments transmitted by the media server 40.

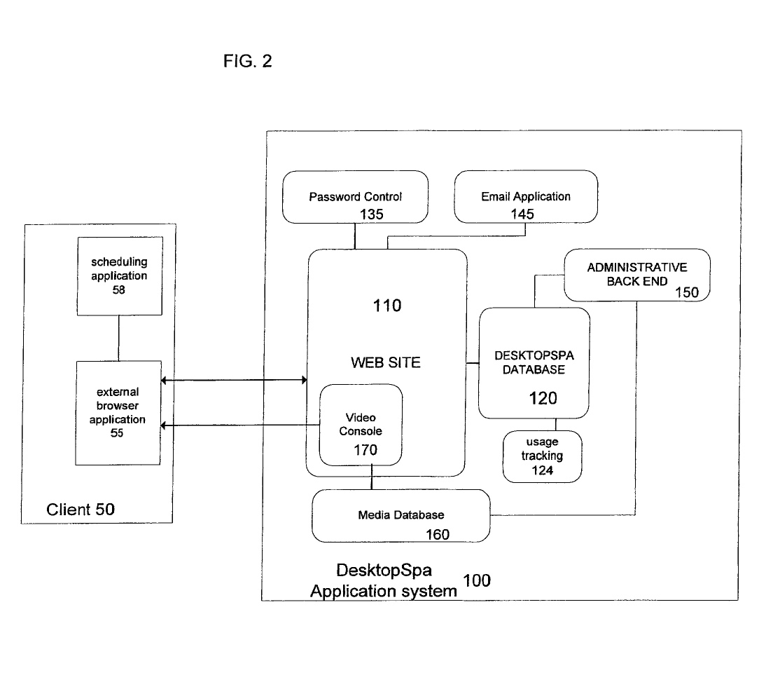

FIG. 2 illustrates an embodiment of the DesktopSpa application, including client components 50 and a server application system 100. The client 50 access the DesktopSpa Web site 110, or front end, using a browser application 55. The Web site 110 includes the Web pages and forms accessible to the user through the browser 55. The Web site may be implemented using DHTML or other known Web page formatting languages. Other non-accessible modules add functionality to the Web Site 110. A password and registration control module 135 performs registration and authentication processing functions that control further access to information in the site. The DesktopSpa database 120 stores in organized form the information pertinent to the site 110. For example, if a Web page in the Site offers the client an opportunity to list various treatments related to a particular ailment, a query is sent to the database 120 which responds by outputting the relevant list, which can then be displayed on a Web page. A usage tracking module 124 stores a transaction log of the Web pages visited and the selections chosen by each client.

The Web site draws health treatment content from a media database 160, which delivers multimedia files to an audio-video console 170 displayable to the client 50 in conjunction with the Web site 110. The audio-video console may be A RealPlayer™ or similar modular audio-video presentation application. As noted above, the various modules of the server application such as the Web site, the database 120 and the media database 160 need not be co-located. The server application system 100 is accordingly not necessarily embodied in a single physical site.

The Web Site also interacts with an email application 145 through a CGI interface (Common Gateway Interface). Through the email application 145, a client can opt to send a health treatment intervention embedded within an email message to an external third party.

The administrative back end 150 provides a user interface accessible to site administrators for the purpose of modifying and updating information stored in the DesktopSpa database 120 and the media database 160. Important modification and updating operations include uploading new interventions into the media database, adding new health issue categories and modifying a particular client's personal information in the database 120.

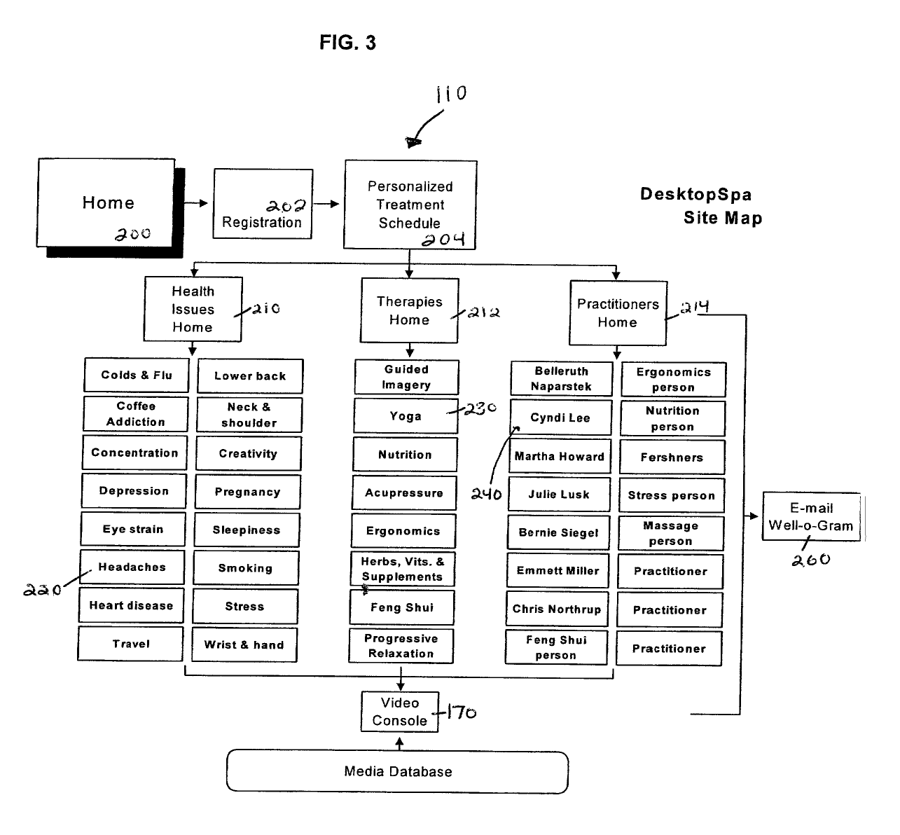

The front end client-Web site interaction will now be described in greater detail. FIG. 3 is an embodiment of a site map of the DesktopSpa Web site 110. The Home page 200 is the introductory page of the Web site 110 associated with the domain name www.DesktopSpa.com. The home page includes diagnostic and navigation tools, a recommended health intervention and the audio-video console 170. The client cannot access the other pages of the site 110 until registration and password authentication have taken place. If the client has not yet registered, a registration page 202 may be accessed. After these preliminary steps have taken place, the client has access to the treatment schedule 204 which displays a recommended schedule of treatments for the client for the day. The navigation tools can be used to navigate between the health issues, therapies and practitioners home pages 210, 212, 214, which provide a list and short explanations of the various individual items grouped in each category. From each of the home pages, a Web page devoted to each particular listed health issue (e.g. the headache page 220), therapy (e.g. the yoga page 230) and practitioner (e.g. the Cyndi Lee page 240) can be accessed. From any of these locations, the URL of a specific treatment can be called from the media database 160, viewed with the audio-video console 170, and sent to a third party via the email well o-gram page 260.

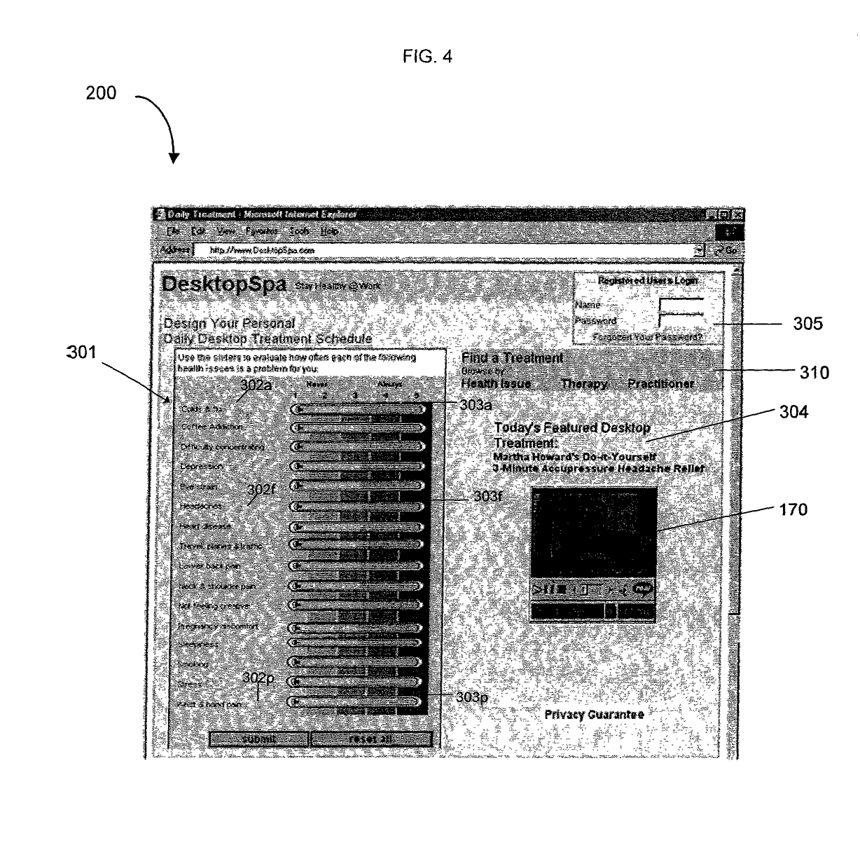

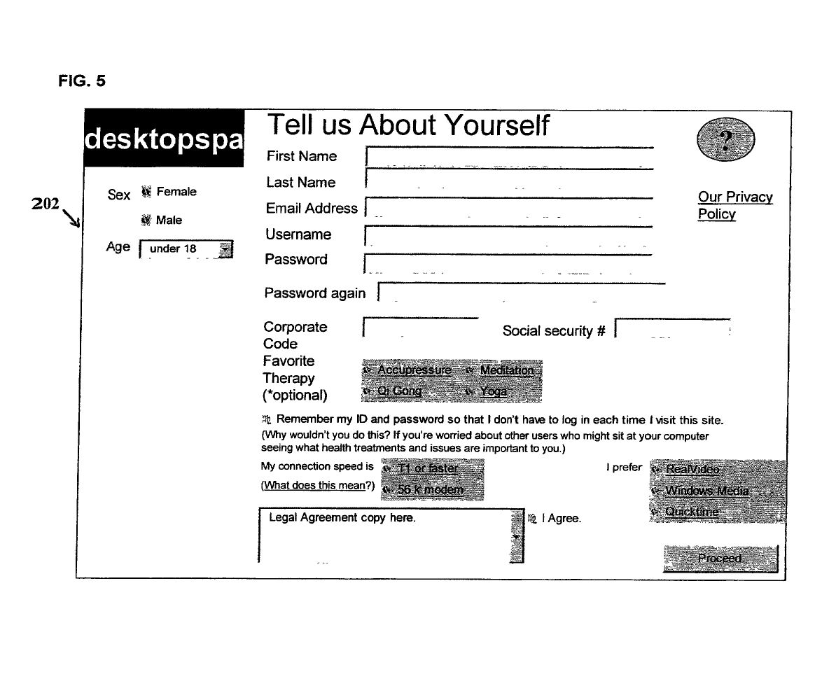

An embodiment of the home page 200 is shown in FIG. 4. On the left side of the page is the diagnostic tool 301 which lists 16 common health issues 302a . . . 302p vertically. Each health issue has a slider 303a . . . 303p beside it that runs on a scale of 1 to 5. The slider allows the client to rate how often or to what degree of intensity he or she has the health problem with a “1” indicating the issue is rarely a problem and “5” indicating the issue is very often a problem. Using the sliders provided, the client submits his or her particular health issues. The home page also includes a featured daily treatment 304, navigation tools 310, the audio-video console 170 and a login dialog box 305 for registered users. The password and registration control module 135 recognizes when a registered client logs in via a cookie inserted into the client browser 55 during initial registration. If a client has not yet registered, the password and registration control module 135 recognizes an unregistered user and opens a registration page 202, an embodiment of which is shown in FIG. 5.

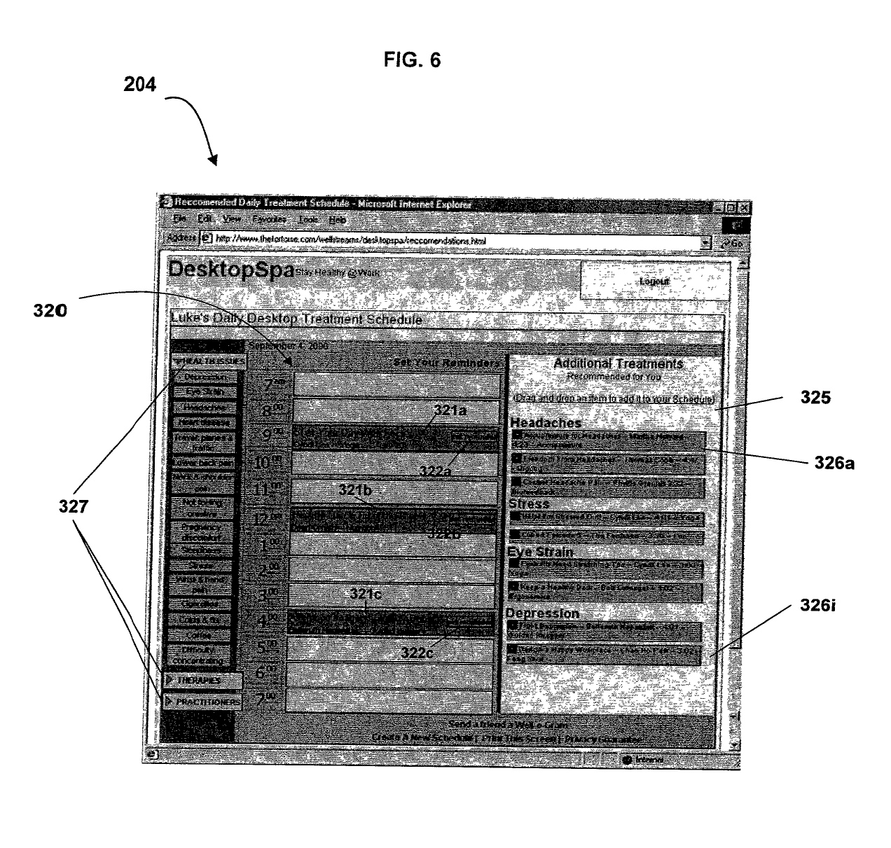

In an alternative embodiment, the home page 200 includes a scheduling interface. When a new user enters the site 110, the home page schedule is filled with that day's recommended daily desktop treatments. This interface would be appear similar to the personal calendar shown in FIG. 6 described below.

The registration page 202 (in FIG. 5) is a form containing various information fields to be filled in by the prospective registrant. The fields include identification information such as name, email address and password, and also include a corporate code. The corporate code is used to configure the Web site 110 in accordance with terms and conditions arranged with the licensing corporation, which may include, for example, specific restrictions on or promotions of particular therapies and treatments. The registration page 202 also requests the input of gender, age, calendar information, favorite therapy and in some cases pregnancy information (not shown) which are used as factors in the process of personalizing a treatment schedule for the client. At the bottom of the page, is a listing of a licensing agreement. After inputting relevant information, and submitting an agreement to the terms of the license, the client becomes registered.

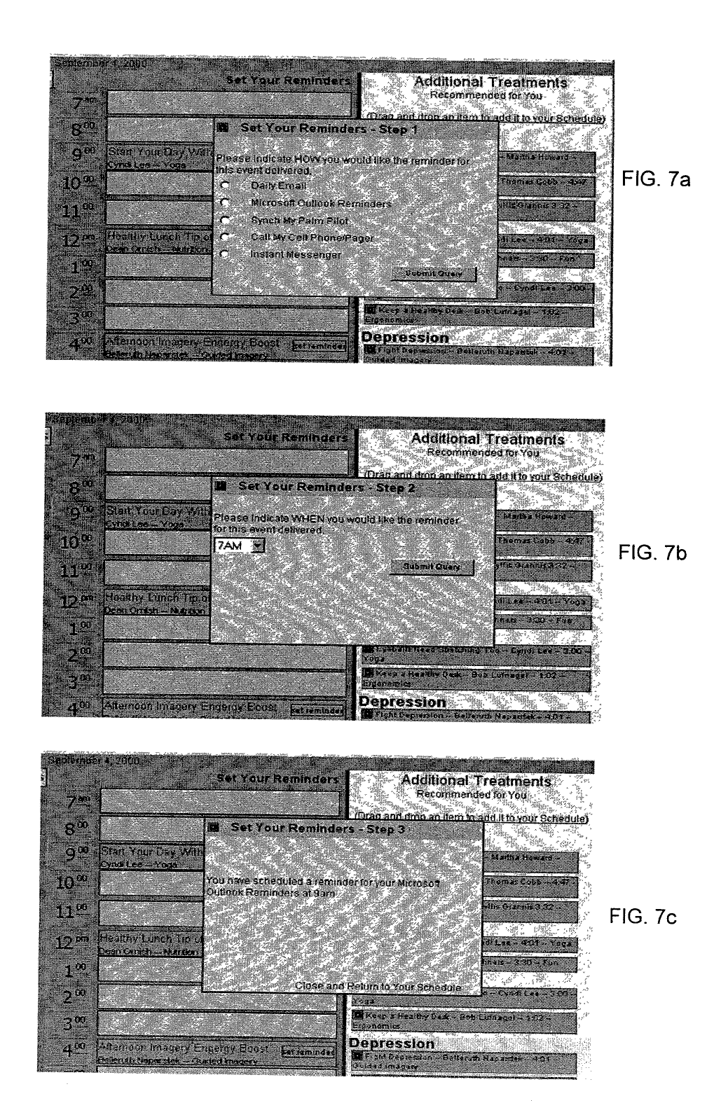

Once a client has registered and entered an appropriate password in the login dialog box 305 of the home page 200, the treatment schedule page 204 is opened. In FIG. 6, an embodiment of the schedule page 204 is shown divided into two parts, a personal calendar 320 and an additional treatments section 325. A navigation tool 327 is also provided shown on the far left. The personal calendar 320 is generated based on the client registration information and the information submitted via the diagnostic tool 301 on the home page. The calendar 320 lists a daily schedule of recommended treatments 321a,b,c. Upon clicking a treatment 321a,b,c, the audio-video console 170 appears, and the treatment program is played. The client can also set reminders that synchronize the treatment schedule to external applications and devices such as Microsoft Outlook, Instant Messenger, email accounts, Palm, PDA and other popular software applications and devices. FIGS. 7a, 7b and 7c illustrate embodiments of the dialog boxes which appear when reminders are set. In FIG. 7a, a dialog box requests the client to provide information as to how the reminder event should be delivered. In FIG. 7b, a dialog box requests a selection of the time to set the reminder to occur, and in FIG. 7c, the dialog box displays a confirmation that a reminder has been set.

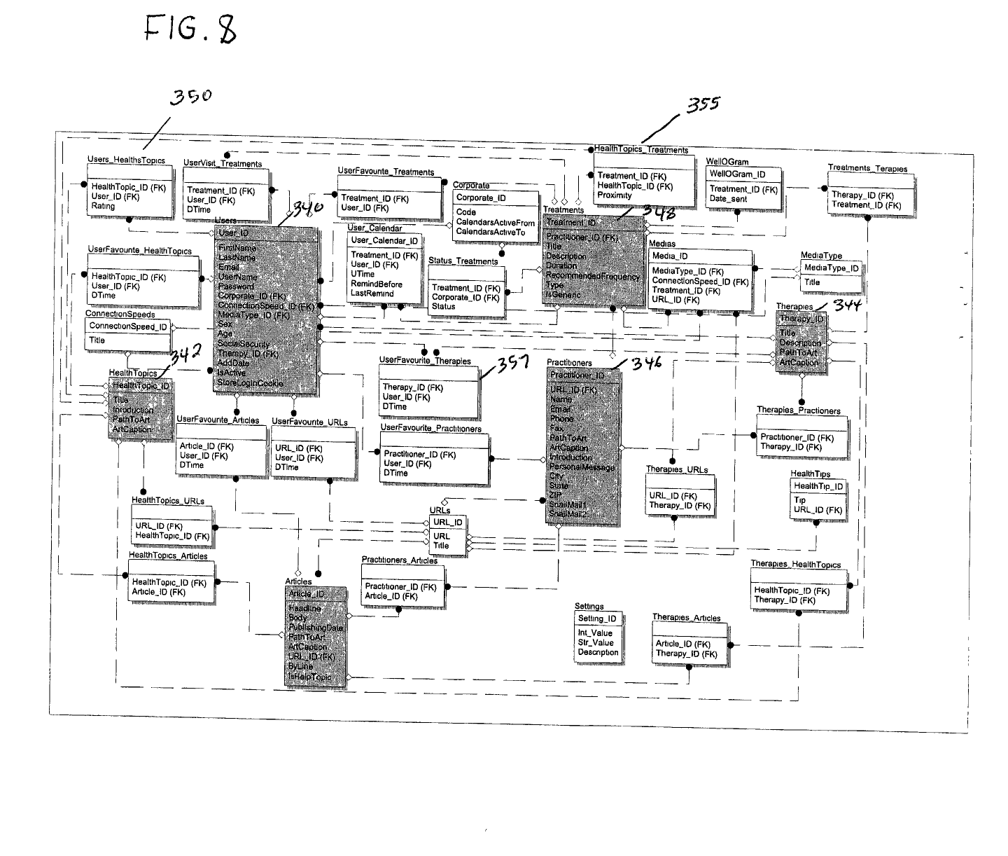

To generate a treatment schedule that is personalized for an individual client, DesktopSpa employs a personalization algorithm that selects several health treatments out of the total range of available treatments determined to be appropriate to an individual client based on the client's input health issue ratings and personal information. To avoid over-prescribing, the number of selected treatments can be limited to a maximum of three or four. If a client wishes to add more treatments to the personal calendar 320 (in FIG. 6), additional treatments can be dragged on dropped into the calendar from the additional treatments section 325 which includes a list of additional treatment entries 326a,b . . . f. The operation of a personalization algorithm can be explained with reference to an implementation of a database schema for the DesktopSpa application shown in FIG. 8. FIG. 8 displays an embodiment of a relational database where each box represents a table. Each table contains numerous records which include the fields listed in each particular table box. The primary tables are a User table 340, which stores a list of DesktopSpa clients along with their personal information, a HealthTopics table 342, which stores a list of all the health issues treated, a Therapies table 344, a Practitioners table 346, and a Treatments table 348, each storing a list of all members of the category along with specific information pertinent to each. Other tables are created using database association operations. For example, a Users_HealthTopics table 350 associates a health issue (HealthTopic_ID) from the HealthTopic table 342 with a User_ID from the Users table 340 and further links these two fields with a rating provided by the client (having the particular User_ID) through the diagnostic tool 301 (in FIG. 4). Each record in the Users_HealthTopics table 350 contains a health issue, a client identification and a rating given by the client to the health issue.

Similarly, a HealthTopics Treatments table 355 associates a treatment with a health issue and also provides a proximity value quantifying the appropriateness of using a particular treatment to treat a particular health issue. The proximity value is assigned by an administrator. An example record in the HealthTopics_Treatments table 355 might be treatment: biofeedback; health issue: eye strain; proximity: 3/10.

A personalization algorithm may include searching the Users_Health Topics table 350 using the User_ID of the client as a search key for health issues rated above a threshold value. This initial search may yield several health issues. The health issues are used in a secondary search of the HealthTopics_Treatments table 355 to find all treatments with a proximity greater than another threshold value for each of the relevant health issues. The secondary search yields a “rough” result group of treatments that can be entered in the personal calendar 320 (in FIG. 6) in the schedule page 204.

Numerous refinements can be added in a given implementation of a personalization algorithm. The Treatment table 348 may include a recommended time filed (not shown) which can be employed to determine an optimal time of the day to schedule a treatment. Information in the UserFavorite_Therapies table 357 can be used to winnow down the group of selected treatments further to better satisfy a client's preferences. More complex schemes may also be used. The age, gender, and pregnancy status of a client can be factored in during treatment selection. Better health may be promoted by combining various therapy types in a more comprehensive daily treatment schedule. These and other selection techniques based on the universe of information contained in the database are within the scope of the present invention.

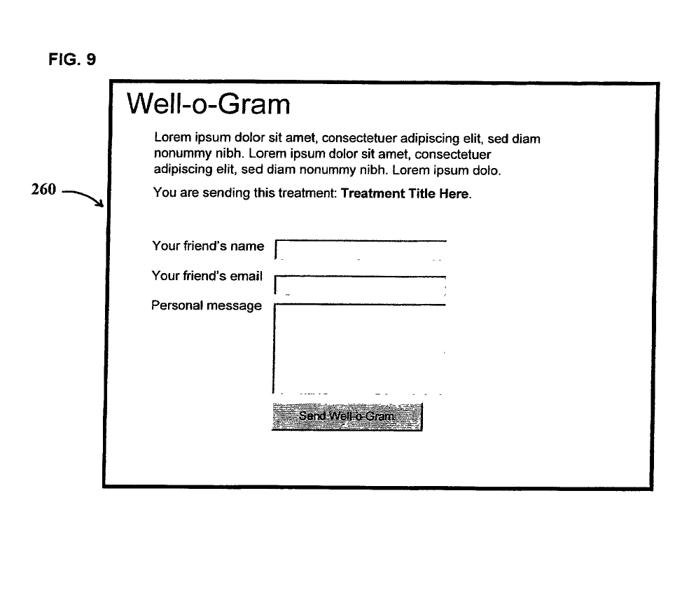

Once a daily treatment schedule is prepared and entered into the personal calendar 320 on the schedule page 204, the client has an opportunity to obtain the treatments and also to send the treatments to a third party via a well o-gram. FIG. 9 shows an embodiment of an interface 260 for entering a destination name, address and message. When a send button is pressed, the treatment and the message are sent to the destination address.

Referring to the site map of FIG.3, from the schedule page 204, using the navigation tool 327 a client can access the health issues, therapies and practitioners homes pages 210, 212 and 214. Each of these pages contain brief descriptions and links to individual pages. The home pages contain navigation bars allowing navigation between categories.

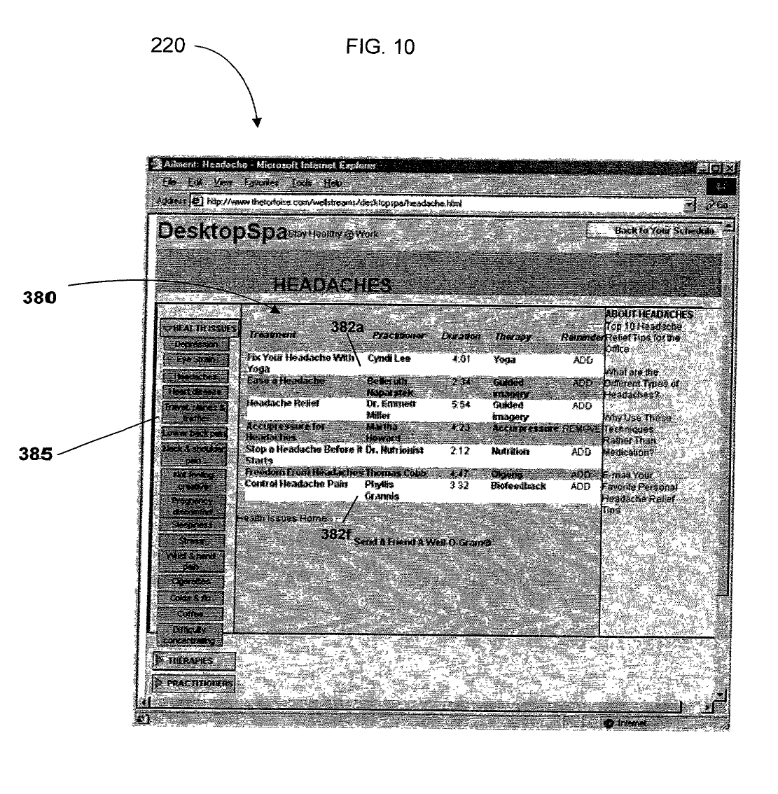

An individual health issue page for headaches 220 (in FIG. 3) is shown in FIG. 10. The central portion of the page 380 shows a list of all treatments 382a . . . f appropriate for the headaches (determined from the HealthTopics_Treatments table 355 as discussed above). Each treatment is listed by title, duration, therapy and practitioner. For example, the treatment 382a is “Fix your headache with Yoga”, a yoga therapy by Cindy Lee lasting 4.01 minutes. Clients are able to add or remove the treatments from their personal calendar 320. Clicking a treatment opens the audio-video console 170 for presentation of the treatment. The headaches page 220 contains the familiar navigation bar 385 on the left and an about column on the right 387 contains links to article pages containing text content specifically concerning headaches.

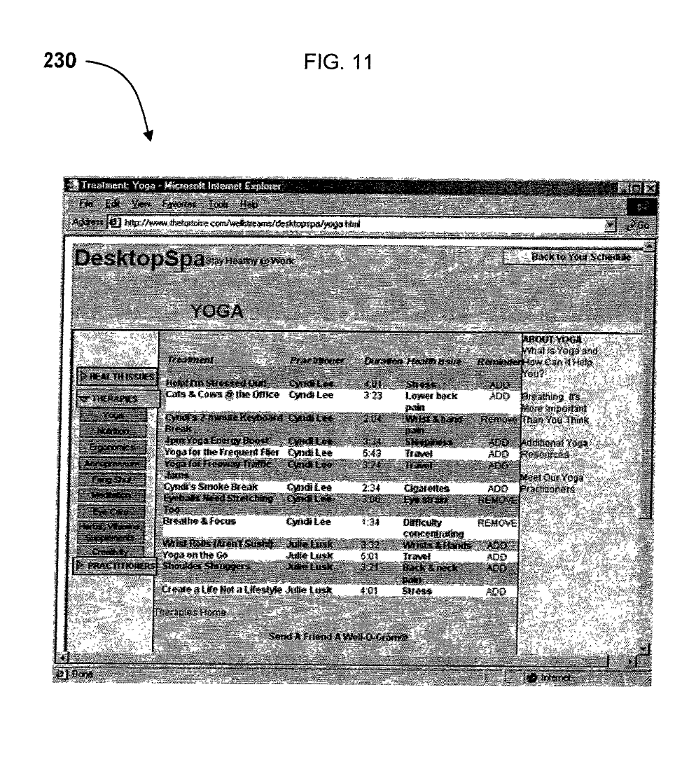

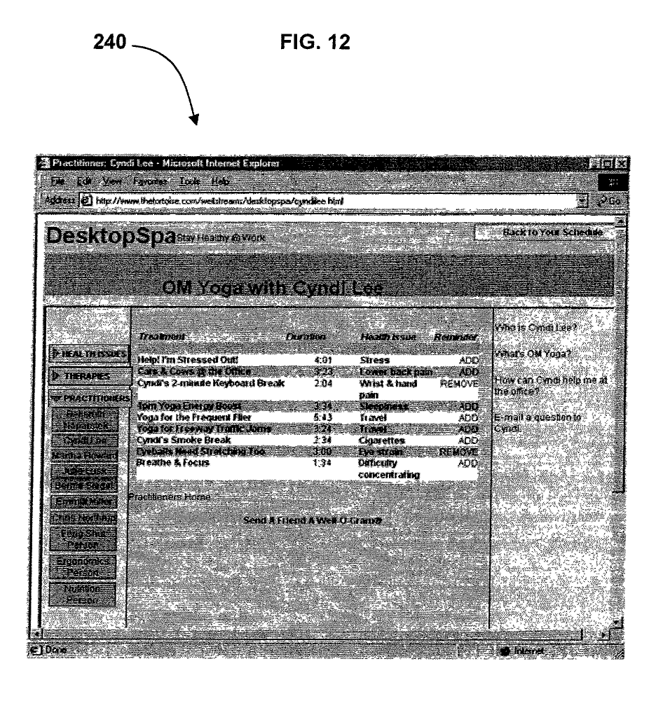

FIGS. 11 and 12 show embodiments of individual therapy and practitioner pages. Like the headache page 220 shown in FIG. 10, the Yoga therapy page 230 (FIG. 11) and the Cyndi Lee practitioner page 240 (FIG. 12) contain a central treatment interface, a navigation bar and an about column. With respect to the practitioner page 240, in alternative embodiments, additional features and functionality may be added, such as real-time live chat with an online practitioner. The times and dates of these chats can be added to the clients personal calendars. In addition, bulletin boards and video conferencing for one-on-one appointments can be presented through both the text and audio-video interfaces attached to the DesktopSpa application Web site 110.

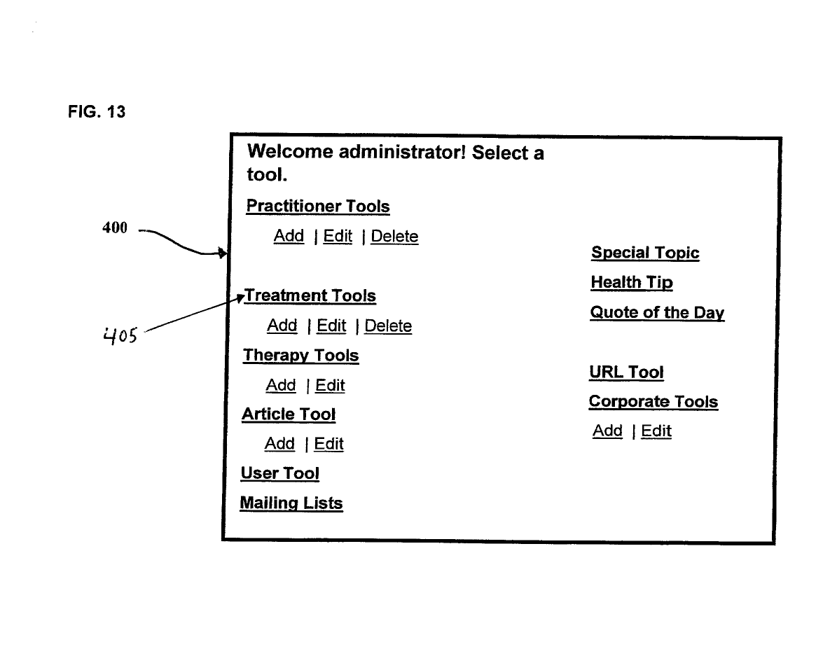

Referring back to FIG. 2, the administrative back end 150 offers administrators the opportunity to modify and add information to the DesktopSpa database 120. The back end is a separate site that includes a user interface. The user interface is navigable, and contains various Web page forms able to receive inputs of data from administrators. FIG. 13 shows a tool home page 400 containing a menu of available options for additions and edits. Activation of any of these options opens a Web page form containing various information entry boxes. Administrators can add to or modify the information within the entry boxes to perform such task as adding a treatment, changing a special topic, and altering the features a corporation desires with respect to the DesktopSpa application.

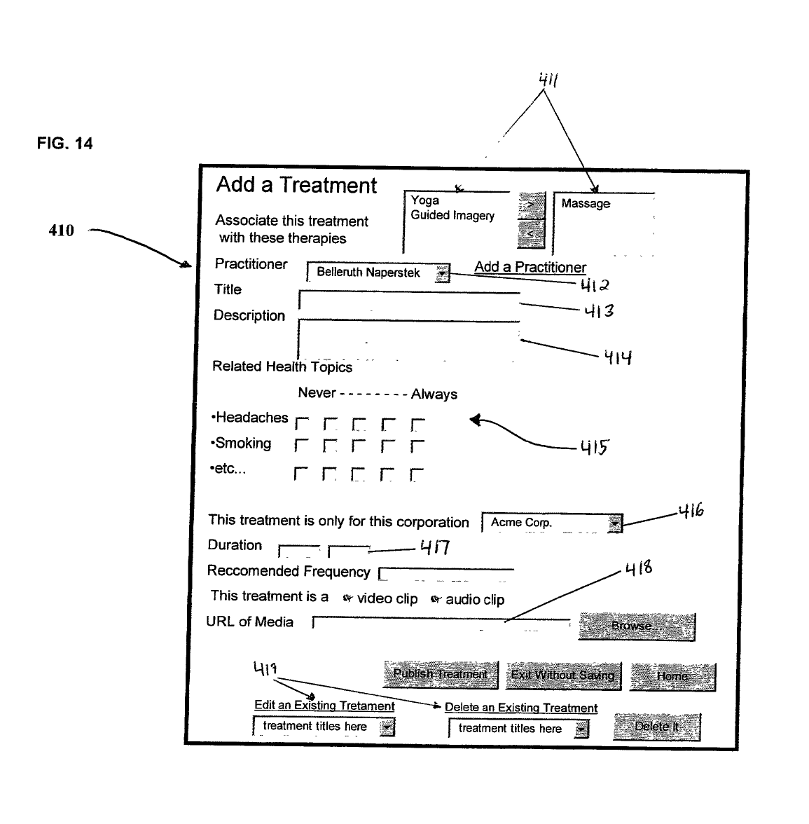

Among the listed features, FIG. 13 contains a treatment tools heading 405 under which add, edit and delete options are presented. FIG. 14 shows an embodiment of a treatment addition Web form 410. The treatment is associated with therapies using the therapy boxes 411. Specific information about the treatment is entered using the practitioner, title and description boxes 412, 413, 414. In the related health issues section 415, the administrator enters a proximity rating indicating the degree to which the treatment should be used to treatment the health issue. These values enter into the HealthTopics_Treatments table 355 discussed above in connection with the database schema. Using a drop down list in the corporation box 416, an administrator can target the treatment to a particular corporation. The duration of the treatment is entered in box 417, and the URL of the media resource in the media database 160 is entered in the URL box 418. This URL also enters a database table that links the treatment to the URL. The treatment addition page 410 also contains an embodiment of a navigation tool 419 at the bottom of the page which allows an administrator to switch to an edit or delete Web page to perform the respective operations on a pre-existing treatment.

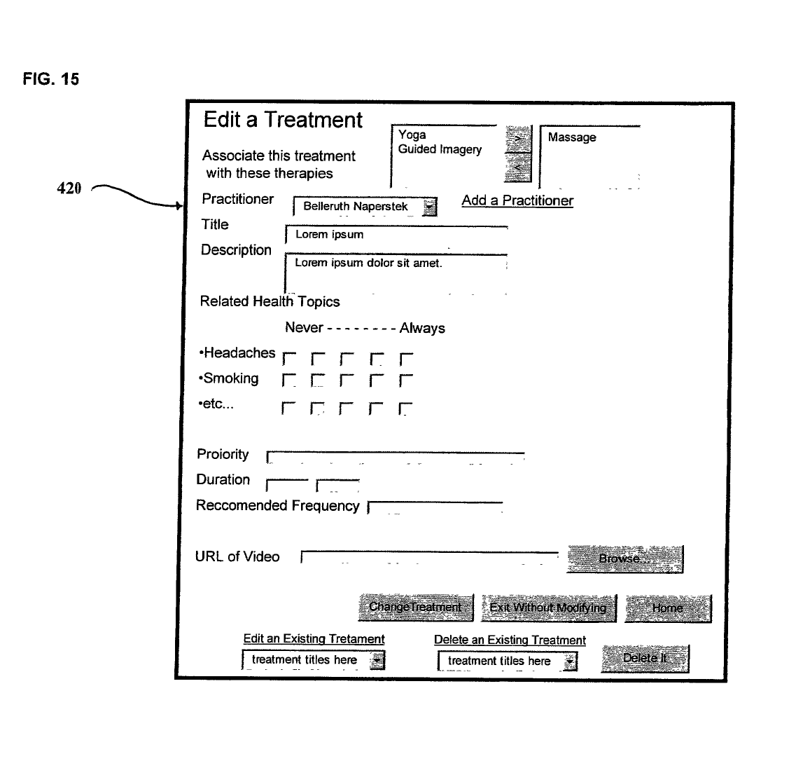

An embodiment of a treatment edit page 420 is shown in FIG. 15. The features and format of the page track the treatment addition page of FIG. 14. The difference being that when the edit page 420 is called up, previously entered information appears in the entry boxes.

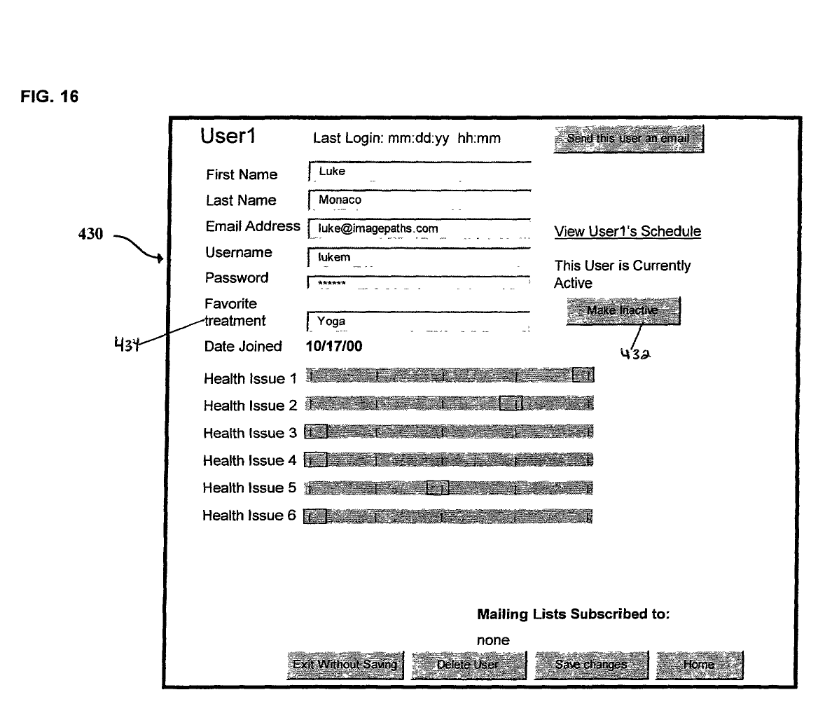

Administrators can also modify information originally input by clients. In a user tool page 430, an embodiment of which is shown in FIG. 16, the administrator can edit all of the information except for the client username and password. An administrator can also block client access to the DesktopSpa application by using the make inactive key 432 in case a client does not comply with the terms of the license. Clicking the favorite treatment link 434 brings up a display of all times that the treatment was viewed by the client. Other uses tracking features (not shown) may be added to display all the treatments viewed.

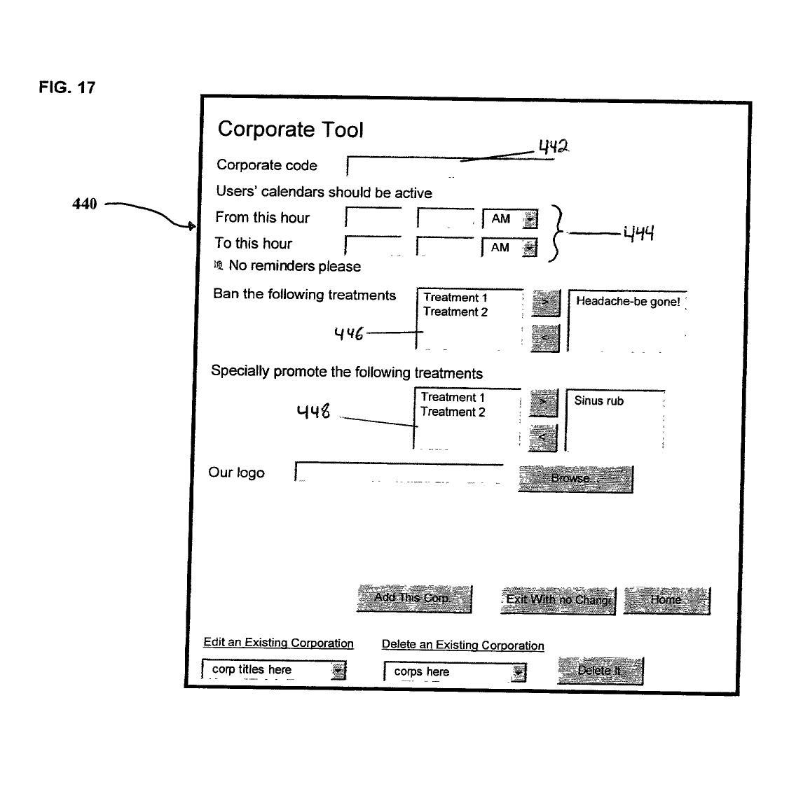

Another example of a back end 135 utility is the corporate tool 440, an embodiment of which is shown in FIG. 17. This feature is particularly important because it allows administrators to tailor the DesktopSpa application in accordance with corporate guidelines. A corporate identification is entered into a code entry box 442. Client records will generally contain the corporate code field indicating the corporation they work for. A general code 999’ may be used to indicate independent clients who do not work for a corporation. A timing section 444 is used to set times during which health interventions can be downloaded through the DesktopSpa application. A corporation may wish to limit access to a lunch period or to late in the afternoon, or alternatively may place no restrictions on timing. A treatment restriction entry box 446 stores a list of health treatment interventions that should not be sent to clients in the corporation. Conversely, a treatment promotion box 448 stores a list of treatments that the corporation desires to be particularly promoted. Whether a treatment is promoted also factors in to the personalization algorithm, promoted treatments accorded a higher probability of being selected for entrance into a personal calendar 320.

Other back end Web pages such as the article tool, although not specifically described in detail, contain features analogous to those illustrated with respect to other tools. In the foregoing description, the method and system of the present invention have been described with reference to a number of examples that are not to be considered limiting. Rather, it is to be understood and expected that variations in the principles of the method and apparatus herein disclosed may be made by one skilled in the art and it is intended that such modifications, changes, and/or substitutions are to be included within the scope of the present invention as set forth in the appended claims. For example, the Web site client interface 110 also provides editing pages that permit a client to change his or her personal information and prior selections. Furthermore, it is noted that modifications made to the format and design of the various Web pages are also within the scope of the present invention.

What is claimed is:

1. A method of delivering personalized health interventions to a client over a computer network comprising:
providing a user interface to a client over the computer network;
receiving information input to the user interface by the client through the computer network related to health issues;
determining personalized health interventions for the client based on the received information; and
delivering at least one of audio and visual health interventions to the client for display on the user interface over the computer network.

2. The method of claim 1, further comprising:
matching the health issue information provided by the client with health intervention criteria stored in a database.

3. The method of claim 1, further comprising:
generating an interactive schedule of daily health interventions for the client; and
sending the schedule to the client over the network;
wherein the schedule includes several links to specific health interventions and the client can view the schedule and access the interventions through the user interface.

4. The method of claim 3, further comprising:
enabling the client to set reminders for the health interventions, the reminders being audio or visual alerts.

5. The method of claim 1, wherein the user interface provides navigation tools allowing a client to access various categories of health information.

6. The method of claim 5, wherein the categories of health information include at least health issues, therapies and practitioners.

7. The method of claim 3, wherein the information received from the client related to health issues includes a significance rating number for each of a list of health issues, the rating number indicating the significance of the particular health issue to the client.

8. The method of claim 7, further comprising:
quantifying an appropriateness of using each particular intervention to treat each particular health issue as a correlation value;
selecting health issues having a significance rating above a first threshold;
determining interventions having a correlation value above a second threshold with respect to any of the selected health issues; and
entering the determined interventions in the daily schedule.

9. The method of claim 7, further comprising:
integrating factors in determinination of health interventions;
wherein the factors include favored therapy types, client gender, client age, and client pregnancy status.

10. The method of claim 1, further comprising:
determining whether the client is registered; and
determining whether the client is associated with a corporation.

11. The method of claim 10, further comprising:
preventing further access to the user interface if the client is not registered; and
incorporating rules for providing interventions and services in accordance with corporation guidelines.

12. The method of claim 11, wherein the rules include restrictions on types of intervention that may be delivered, times of day during which interventions can be delivered, and promotions of particular interventions.

13. The method of claim 1, further comprising:
maintaining a database of health and client information through a back end interface.

14. The method of claim 13, further comprising:
adding interventions, therapies, health issues and practitioners to the database to expand health services; and
modifying client information and health information in the database.

15. The method of claim 14, further comprising:
storing audio and visual health interventions in a media file server; and
linking interventions included in the database to a corresponding media file in the media file server.

16. The method of claim 4, wherein the generated schedule is integrated into a local scheduling application at a client computer.

17. The method of claim 16, further comprising:
providing an email interface, the interface allowing a client to send a health intervention accessible through the user interface to a third party in an email message.

18. The method of claim 1, further comprising:
delivering general daily health advice and recommendations over the computer network to the user interface.

19. A system for delivering personalized health interventions to a client over a computer network, comprising:
a Web server adapted to provide a user interface to a client over the computer network, and to receive information from the client through the computer network related to health issues;
a database arrangement including process logic, the database arrangement storing health information resources and personal information received from the client; and
an audio/visual module;
wherein the process logic determines appropriate personalized health interventions for the client based on the received information and the health information resources stored in the database arrangement, the health interventions being delivered to the client over the computer network via the audio/visual module.

20. The system of claim 19, wherein the Web server generates an interactive schedule of daily health interventions for the client and sends the schedule to the client over the computer network, the schedule including a plurality of health interventions viewable and accessible by the client.
